(19) United States
(12) Patent Application Publication
(10) Pub. No.: US 2007/0172244 A1
(43) Pub. Date: Jul. 26, 2007

(54) Electrophotographic image forming apparatus and method for improving transferring properties

(75) Inventors: Sun-woo Lee, Suwon-si (KR); Yong-baek Yoo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/634,163

(22) Filed: Dec. 6, 2006

(30) Foreign Application Priority Data
Jan. 25, 2006 (KR) 10-2006-0007991

(51) Int. Cl. G03G 15/00

(52) U.S. Cl. 399/45

(57) ABSTRACT

An image forming apparatus capable of improving transfer properties, and a method for improving the transfer properties are provided by the invention. According to the method of the present invention, a surface of a photoconductive medium is electrified by applying a voltage to the photoconductive medium. An electrostatic latent image is formed on the surface of the electrified photoconductive medium. A visible image is formed by supplying toner to the surface of the photoconductive medium whereon the electrostatic latent image is formed, and the visible image of the photoconductive medium is transferred onto a paper. In the transferring step, the resistance of the paper is measured, and the image transfer is performed by maintaining a current electrifying potential if the resistance of the paper is lower than a predetermined value and lowering the current electrifying potential of the photoconductive drum if equal to or greater than a predetermined value. Accordingly, the electrifying potential of the photoconductive medium and the developing voltage can be decreased without a dedicated charge removing unit. Therefore, electric charge on the high-resistance paper can be easily removed, and a transfer area can be broadened. Consequently, a phenomenon such as image scattering can be prevented.

### CROSS-REFERENCE TO RELATED APPLICATION

This application claims benefit under 35 U.S.C. § 119(a) of Korean Patent Application No. 2006-7991, filed Jan. 25, 2006, the entire content of which is hereby incorporated by reference.

### BACKGROUND OF THE INVENTION

1. Field of the Invention

The present invention relates to an electrophotographic image forming apparatus. More particularly, the present invention relates to an electrophotographic image forming apparatus having a broad transfer area for various types of paper, and for highly improving transfer properties. The invention is also directed to a method for producing an electrophotographic image.

2. Description of the Related Art

Image forming apparatuses such as a laser printer, a copier and a facsimile generally adopt an electrophotographic system. The electrophotographic image forming apparatus forms a desired image through a process of electrifying, exposing, developing, transferring and fixing. FIG. 1 partially shows a laser printer as a typical example of the electrophotographic image forming apparatus.

Referring to FIG. 1, the electrophotographic image forming apparatus 10 comprises a photoconductive medium 11 having a cylinder shape, an electrifying unit 12 for applying certain charging voltage to a surface of the photoconductive medium 11, a laser scan unit (LSU) 13 for projecting a laser beam onto the surface of the photoconductive medium 11 according to an image signal from a computer, a first charge removing unit 16 for removing an electric charge remaining on the surface of the photoconductive medium 11, a developing unit 14 for developing an electrostatic latent image formed on the surface of the photoconductive medium 11 scanned by the LSU 13 into a visible toner image, a transfer unit 18 for transferring the toner image formed on the photoconductive medium 11 to a paper P, and a fixing unit 19 for fixing the toner image transferred onto the paper P using heat and pressure.

The developing unit 14 comprises a developing roller 14a made of conductive rubber and disposed at a predetermined distance from the photoconductive medium 11 to form a gap therebetween. A toner supplying roller 14b is disposed around the developing roller 14a and rotates in the same direction (The direction of arrow B in FIG. 1) as the developing roller 14a so as to supply toner T from a toner storage 14d to the developing roller 14a. A toner layer control member 14c is provided for controlling the thickness of a toner layer formed on the developing roller 14a.

The transfer unit 18 is provided with a dedicated second charge removing unit 17 which removes an electric charge remaining on the paper P for better transferring performance when the visible toner image formed on the photoconductive medium 11 is transferred to the paper P. The image forming apparatus 10 further comprises a high-voltage power supply (HVPS) 15.

In the electrophotographic image forming apparatus 10, the process for forming an image are as follows. First, the HVPS 15 applies a predetermined voltage to the electrifying unit 12, the developing unit 14, and the transfer unit 18 under the control of a control unit 20. The electrifying unit 12 evenly charges the surface of the photoconductive medium 11 with the electrifying voltage applied by the HVPS 15. The photoconductive medium 11 electrically charged by the electrifying unit 12 rotates in the clockwise direction of arrow A (FIG. 1). The LSU 13 scans the photoconductive medium 11 with the laser beam corresponding to image data input from the control unit 20, accordingly forming an electrostatic latent image.

The toner T is moved by the toner supplying roller 14a rotated in the counterclockwise direction of arrow B, and attached to the developing roller 14a. Therefore, a toner layer having certain thickness is formed on the surface of the developing roller 14a by the toner layer control member 14c. As the developing roller 14a keeps rotating, the toner T is moved to the surface of the photoconductive medium 11 from a developing area where a gap is formed between the developing roller 14a and the photoconductive medium 11. The toner T is attached onto the electrostatic latent image formed on the photoconductive medium 11 and developed to the visible toner image.

Next, the toner image on the photoconductive medium 11 is transferred to the paper P by a transfer voltage applied from the HVPS 15 to the transfer unit 18. During this, since a non-image area potential difference, that is, a difference of potentials between a non-image area and an image area, and a developing area potential difference, that is, a difference of potentials between a developing area and a laser scanning area are designed to be relatively sufficient in general paper, non-image area background can be prevented by applying a specific electrifying potential to the photoconductive medium 11 and a satisfactory image gradation can be obtained. However, when high-resistance paper is used, charge removal from the paper P by the second charge removing unit 17 is difficult. Accordingly, the high-resistance paper generates a phenomenon such as image scattering in a low-density image more often in comparison with the general paper. Thus, the general electrophotographic image forming apparatus 10 has a drawback in that an inferior image is easily generated due to density variations of the image transferred to the paper P according to the resistance value of the paper P.

In order to improve such a problem, JP2002-148964 suggests an image forming method by determining the optimum transfer voltage according to resistance values of the transfer unit 18 and the paper P. According to the disclosed method, when a leading end of the paper P reaches a transfer nip portion, a transfer bias voltage to be applied to the transfer unit 18 is preset according to measured result of resistances of the photoconductive medium 11 and the transfer unit 18. Relatively low bias voltage is applied when using a paper P having low resistance, and relatively high bias voltage when using a paper P having high resistance.

However, when using a specific paper P having a high resistance, it is hard to secure a transfer area using the general image forming method that changes the transfer voltage according to the resistance value of the paper P, due to the image scattering phenomenon in the low-density image. As a result, when using the high-resistance paper P, a dedicated charge removing unit needs to be provided in order to obtain high image quality by preventing the image scattering of the low-density image and securing the transfer area.

### SUMMARY OF THE INVENTION

An aspect of the present invention is to solve at least the above problems and/or disadvantages and to provide at least the advantages described below. Accordingly, an aspect of the present invention is to provide an electrophotographic image forming apparatus capable of securing a broad transfer area even in a specific paper having high resistance.

Another aspect of the present invention is to provide a method for forming an image, capable of securing a broad transfer image even in the high-resistance paper, thereby improving transfer properties as well as guaranteeing high image quality.

In order to achieve the above-described aspects of the present invention, an electrophotographic image forming apparatus is provided that is capable of improving transfer properties, comprising a photoconductive medium having a surface electrified by an electrifying unit; a laser scanning unit for forming an electrostatic latent image on the surface of the electrified photoconductive medium; a developing unit for visualizing the electrostatic latent image into a toner image; a transfer unit for transferring the toner image formed on the photoconductive medium onto a paper; and a control unit for controlling a voltage applied to the photoconductive medium according to the resistance of the paper.

The control unit measures the resistance of the paper, and transfers the image by maintaining a current electrifying potential if the resistance is lower than a predetermined value and lowering the current electrifying potential if equal to or greater than the predetermined value.

According to another aspect of the present invention, an electrophotographic image forming method capable of improving transfer properties, comprises electrifying a surface of a photoconductive medium by applying a voltage to the photoconductive medium; forming an electrostatic latent image on the surface of the electrified photoconductive medium; forming a visible image by supplying toner to the surface of the photoconductive medium and the electrostatic latent image; and transferring the visible image of the photoconductive medium onto a paper, and wherein, in the transferring step, the resistance of the paper is measured, and the image transfer is performed by maintaining a current electrifying potential if the resistance is lower than a predetermined value and lowering the current electrifying potential if equal to or greater than the predetermined value.

In the transferring step, when the resistance of the paper is equal to or greater than the predetermined value, a voltage applied to a developing unit is lowered below a current developing voltage as well as lowering the applied voltage for the photoconductive medium below the current electrifying potential.

According to the image forming method, when the resistance of the paper is equal to or greater than the predetermined value, the applied voltage for the photoconductive medium is lowered by less than 15% with respect to the current electrifying potential. More preferably, the applied voltage is lower by 5˜10%.

In the transferring step, alternating current (AC) or direct current (DC) applied voltage for the developing unit is lowered below a current developing voltage, to prevent an increase of image density occurring when the applied voltage is lowered.

The applied voltage for the photoconductive medium is automatically set according to the resistance of the paper, through mode selection by a suitable computer and software.

These and other aspects of the invention will become apparent from the following detailed description of the invention in conjunction with the annexed drawings which disclose various embodiments of the invention.

### BRIEF DESCRIPTION OF THE DRAWINGS

The above aspects and other features of the present invention will become more apparent by describing in detail exemplary embodiments thereof with reference to the attached drawing figures, wherein;

FIG. 1 shows a structure of a general electrophotographic image forming apparatus of the prior art;

FIG. 2 shows a structure of an electrophotographic image forming apparatus according to an embodiment of the present invention;

FIG. 3 is a detailed view of FIG. 2, showing a photoconductive medium and a transfer unit; and

FIG. 4 is a flowchart depicting a method for forming an image in an electrophotographic image forming apparatus according to an embodiment of the present invention.

### DETAILED DESCRIPTION OF THE EXEMPLARY EMBODIMENTS

Hereinafter, an embodiment of the present invention will be described in detail with reference to the accompanying drawing figures.

In the following description, same drawing reference numerals are used for the same elements in the different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

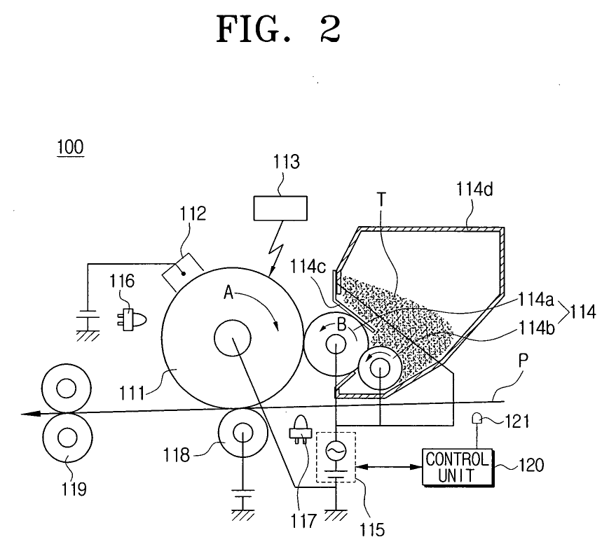

FIG. 2 shows the structure of an electrophotographic image forming apparatus according to an embodiment of the present invention. Referring to FIG. 2, the image forming apparatus 100 comprises a photoconductive medium 111 having a surface electrified by an electrifying unit 112, and a laser scanning unit (LSU) 113 for forming an electrostatic latent image on the surface of the electrified photoconductive medium 111. A developing unit 114 is provided for developing the electrostatic latent image into a visible toner image. A transfer unit 118 for transferring the toner image formed on the photoconductive medium 111 onto paper P is positioned below the photoconductive medium. A control unit 120 is provided for controlling a voltage supplied to the photoconductive medium 111 according to the resistance of the paper P.

The photoconductive medium 111 is a part for forming thereon the electrostatic latent image that will be printed out by a light projected from the LSU 113. An organic photoconductive (OPC) drum is generally used for the photoconductive medium 111. Under the control of the control unit 120, the LUS 113 projects a light corresponding to image data onto the photoconductive medium 111, thereby forming the electrostatic latent image on the photoconductive medium 111.

The electrifying unit 112 charges the photoconductive medium 111 with a predetermined electrifying voltage applied from a high-voltage power supply (HVPS) 115. In the electrophotographic image forming apparatus 100, the voltage applied to the photoconductive medium 111 varies depending on the type or specification of the apparatus. Also, even in the same apparatus 100, the applied voltage may vary according to inner temperature and/or humidity of the apparatus 100. The applied voltage is controlled by the control unit 120 to vary corresponding to the inner temperature and/or humidity. For example, the voltage to be applied to the photoconductive medium in a general color laser printer is set to be in a range of −600˜−500V.

The developing unit 114 comprises a developing roller 114a and a supplying roller 114b, develops by toner T the electrostatic latent image formed on the photoconductive medium 111 by the LSU 113. More specifically, the toner T is moved from the supplying roller 114b to the developing roller 114a by a potential difference between the supplying roller 114b being applied with a predetermined supplying voltage and the developing roller 114a being applied with a predetermined developing voltage. Accordingly, the toner image is formed on the area corresponding to the electrostatic latent image of the photoconductive medium 111. The developing unit 114 further comprises a toner layer control member 114c for controlling a toner layer formed by the toner supplied to the developing roller 114a.

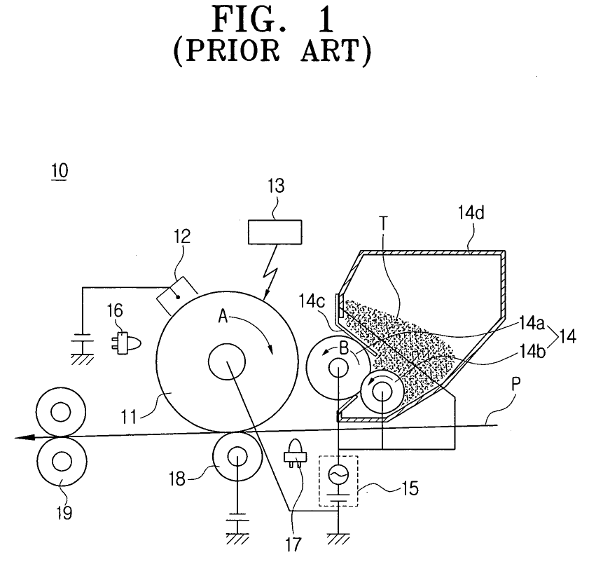

For better performance of transfer when the visible toner image is transferred to the paper P, the transfer unit 118 is provided with a dedicated second charge removing unit 117 which removes an electric charge remaining on the paper P. Since these structures are the same as in the conventional image forming apparatus 10 explained with reference to FIG. 1, detailed description thereof will be omitted herein.

The control unit 120 controls overall signals of the photoconductive medium 111, the LSU 113, the developing unit 114, the transfer unit 118, and the HVPS 115. Especially in the image forming apparatus 100 according to the embodiment of the present invention, the control unit 120 controls the voltage applied to the photoconductive medium 111 according to the resistance of the paper P measured by a sensor 121. When the resistance of the paper P measured by the sensor 121 is lower than a predetermined value, the control unit 120 controls the applied voltage to maintain the current electrifying potential at a substantially constant level. When the measured resistance is equal to or greater than the predetermined value, the control unit 120 controls the applied voltage to be lower than the current electrifying potential. Preferably, the voltage applied to the photoconductive medium 111 is automatically controlled in accordance with the measured resistance of the paper P through mode selection by suitable software and a computer.

Hereinafter, an electrophotographic image forming method will be described with reference to the accompanying drawings.

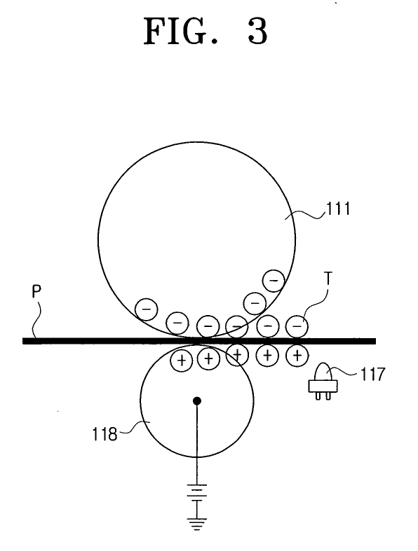

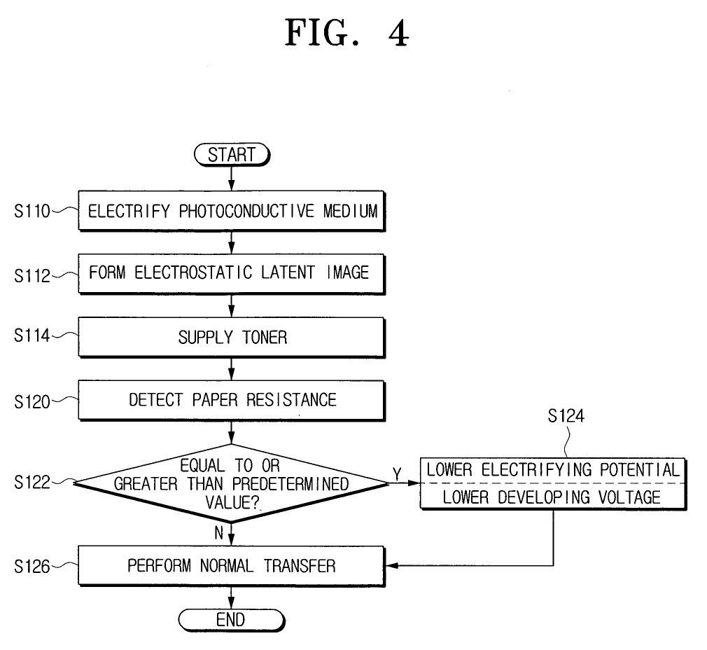

FIG. 3 is a partial enlarged view showing the photoconductive medium 111 and the transfer unit 118, for explaining image forming processes in the image forming apparatus 100 according to an embodiment of the present invention. FIG. 4 is a flowchart for explaining the method.

Referring to FIGS. 3 and 4, according to the image forming method of an embodiment of the present invention, the voltage is applied to the photoconductive medium 111, thereby electrifying the surface of the photoconductive medium 111 to a negative electric charge (indicated by box S110). When approximately −5 kV˜−7 kV of voltage is applied to the electrifying unit 112 by the HVPS 115, the photoconductive medium 111 is electrified to have a predetermined electric charge of approximately −600˜−500V by corona discharge.

Then, a laser beam corresponding to the image data is projected by the LSU 113 onto the surface of the photoconductive medium 111 so that a desired electrostatic latent image is formed (indicated by box S112). When the laser beam is projected on the photoconductive medium 111, the electrified area on the photoconductive medium 111 is neutralized. The relatively strong negative electric charge (approximately −600˜−500V) of the electrified area scanned with the laser beam is weakened to a relatively low negative electric charge (approximately −40˜−50V). As a result, the negative electric charge remains on a non-exposed area, and an exposed area (electrostatic latent image) is neutralized to have constant potential difference.

The toner T is supplied to the surface of the photoconductive medium 111 bearing the electrostatic latent image thereon, thereby forming the visible toner image (indicated by box S114). Since having negative properties, the toner T easily jumps onto the electrostatic latent image on the photoconductive medium 111 and forms the visible image.

The visible image of the photoconductive medium 111 is transferred onto the paper P by applying a positive transfer voltage to the transfer unit 118. Generally, the positive voltage of approximately 5˜7 kV is applied, so that a rear side of the paper P is electrified to the positive electric charge by the corona discharge. Because static electricity by the corona discharge is greater than an adhesive force of the toner T with respect to the photoconductive medium 111, the toner image is attached to a front side of the paper P disposed between the transfer unit 118 and the photoconductive medium 111 while being drawn toward the transfer unit 118. Thus, the visible image is produced.

Generally, the positive electric charge remaining on the rear side is removed by the second charge removing unit 117 since the paper is advanced with the rear side thereof electrified to the positive electric charge. However, when using a high-resistance paper P, because significant polarization occurs, the electric charge is not completely removed from the rear side of the paper P in spite of the operation of the second charge removing unit 117, as shown in FIG. 3. Therefore, when the high-resistance paper P enters the gap between the photoconductive medium and the transfer unit 118, a narrow transfer area is formed. Also, in general image forming apparatuses, the transfer voltage is set within a predetermined range according to the resistance of the paper P. Therefore, when the paper P having resistance is beyond the acceptable range is used, image scattering is generated due to the narrow transfer area.

A special resistance of the paper herein refers to a paper resistance beyond the control of the electrophotographic image forming apparatus, in a certain image forming apparatus being currently in use. For example, when all conditions of the currently used image forming apparatus are set for a paper having resistance of 1˜8 MΩ, a paper having resistance of 9 MΩ is considered to have the special resistance.

When using the high-resistance paper P, having a resistance which exceeds the predetermined value, a phenomenon such as the image scattering is generated. As the electrification degree of the paper increases, charge removing properties is decreased, thereby increasing the potential difference between the photoconductive medium and the paper P. The image scattering is caused by such increase of the potential difference. Most image forming apparatuses measure the resistance of the paper P and control the predetermined range of the transfer voltage according to the resistance, during the transfer step. However, in case of using the high-resistance paper P, the image scattering cannot be prevented with certainty only by setting the transfer voltage as described above.

According to the embodiment of the present invention, the paper resistance is measured in the transfer step, and the electrifying voltage of the photoconductive medium 111 is adjusted according to the resistance with the transfer voltage maintained. When the resistance is below the predetermined value, the transferring operation is performed with the applied voltage maintaining the current electrifying potential. When the measured resistance is equal to or greater than the predetermined value, the applied voltage is controlled to be lower than the current electrifying potential. In order to prevent image density from increasing by the lowered electrifying potential, an alternating current (AC) or a direct current (DC) being applied is controlled to be lower than the developing voltage used for general paper.

As shown in FIG. 4, the resistance of the paper P is measured by the sensor 121 (indicated by box S120). The control unit 120 determines whether the measured resistance belongs to the special resistance (indicated by box S122). If not, the transferring operation can be normally performed with the current electrifying potential (indicated by box S126). If so, on the contrary, the electric potential of the photoconductive medium 111 is lowered to reduce the potential difference of the photoconductive medium 111 (indicated by box S124). As the potential difference between the photoconductive medium 111 and the transfer unit 118 increases, the transfer area is broadened. As a consequence, the image scattering caused in a low-resistance image can be prevented. More specifically, it is preferred that the voltage applied to the photoconductive medium 111 is reduced from the current electrifying potential by less than 15%. More preferably, the applied voltage is reduced by 5˜10%.

The applied voltage for the photoconductive medium 111 may be automatically controlled according to the paper resistance, through the mode selection by suitable software and computer.

When the applied voltage for the photoconductive medium 111, that is, the electrifying potential is lowered, the image density may increase in comparison with general developing processes. Therefore, developing conditions are preferably controlled as well as lowering the electrifying potential for the photoconductive medium 111 (S124). The developing conditions may be the developing voltage such as the AC or DC voltage. Control of the AC voltage means control of a peak-to-peak voltage. Change of the image density caused by the lowered applied voltage can be prevented by lowering one of the AC voltage and the DC voltage. In other words, even with respect to the high-resistance paper P, change of the image density can be compensated as well as securing a sufficient transfer area.

The above-explained electrophotographic image forming method is applicable to any type of electrophotographic image forming apparatuses which transfers an image with one or more colors. It will be understood that the image forming apparatus should control the voltage applied to the photoconductive medium 111 and the developing unit 114 by the control unit 120 according to the paper resistance.

Hereinafter, a preferred embodiment of the present invention will be described in detail.

### Embodiment 1

The transfer voltage is measured in a color laser printer while printing an image on a paper 1 (premium paper of a company A) with the current applied voltage (electrifying potential) for the photoconductive medium 111 set to −550V.

Here, as printing conditions, an inner temperature of the apparatus is about 10° C. and humidity about 10%. While performing normal printing in this state, the transfer voltage is 2058V, the maximum voltage 2339V, the minimum voltage 1821V, and the transfer area (αTR=Vmax−Vmin) 518V.

Now, the printing is performed using the paper 1, with the applied voltage set to −500V through mode selection by the computer and software. While performing normal printing, the transfer voltage is 2310V, the maximum voltage 2236V, the minimum voltage 1511V, and the transfer area (ΔTR) 725V.

### Embodiment 2

The transfer voltage is measured while printing an image on a paper 2 (SanYi paper of a company B). The other conditions but the type of the paper used are all the same as in the Embodiment 1. The results are shown in Table 1.

### Embodiment 3

The transfer voltage is measured while printing an image on a paper 3 (Hammermill paper of a company C). The other conditions but the type of the paper used are all the same as in the Embodiment 1. The results are shown in Table 1.

### Embodiment 4

The transfer voltage is measured while printing an image on a paper 4 (Xerox4024 paper of a company D). The other conditions but the type of the paper used are all the same as in the Embodiment 1. The results are shown in Table 1.

TABLE 1

| | Embodiment | | Embodiment | | Embodiment | | Embodiment | |
|---|---|---|---|---|---|---|---|---|
| Class | 1 | | 2 | | 3 | | 4 | |
| Applied | −550 | −500 | −550 | −500 | −550 | −500 | −550 | −500 |
| voltage(V) | | | | | | | | |
| Maximum | 2339 | 2236 | 2428 | 2739 | 2428 | 2502 | 2280 | 2383 |
| voltage | | | | | | | | |
| Normal | 2058 | 2310 | 2147 | 2236 | 2058 | 2147 | 2117 | 2310 |
| voltage | | | | | | | | |
| Minimum | 1821 | 1511 | 1984 | 1777 | 1688 | 1466 | 1910 | 1718 |
| voltage | | | | | | | | |
| Transfer | 518 | 725 | 444 | 962 | 740 | 1036 | 370 | 665 |
| area(ΔTR) | | | | | | | | |

As shown in Table 1, when the applied voltage for the photoconductive medium 111 is lowered, maintaining the normal transfer voltage, the transfer area is increased in various types of papers. In other words, in the image forming apparatus, as the transfer area increases in such various types of papers, the transferring operation can be performed better regardless of the types of papers. As a result, the transfer properties can be highly improved.

### Embodiment 5

The paper 1 is used, and the voltage applied to the photoconductive medium 111 is lowered to −500V. The AC voltage (peak-to-peak voltage) of the developing unit is lowered by approximately 100V. The printing is performed in the same manner as the Embodiment 1. As a result, the transfer area is sure increased, and the image scattering that used to occur in the low-density image is not observed.

### Embodiment 6

The paper 1 is used, and the voltage applied to the photoconductive medium 111 is lowered to −500V The AC voltage (peak-to-peak voltage) of the developing unit is lowered by approximately 50V The printing is performed in the same manner as the Embodiment 1.

The same as the Embodiment 5, the transfer area is increased, and the image scattering that used to occur in the low-density image is not observed.

As described above, according to the embodiments of the present invention, the broad transfer area can be guaranteed in the special paper having high resistance as well as in the general papers. In addition, since the transfer area can be broadened without a dedicated charge removing unit, the transfer properties and the image quality can be improved. Especially, the image scattering in the low-density image can be prevented.

While the invention has been shown and described with reference to certain embodiments thereof, it will be understood by those skilled in the art that various changes in form and details may be made therein without departing from the spirit and scope of the on as defined by the appended claims.

What is claimed is:

1. An electrophotographic image forming apparatus capable of improving transfer properties, comprising:
a photoconductive medium of which a surface is electrified by an electrifying unit;
a laser scanning unit for forming an electrostatic latent image on the surface of the electrified photoconductive medium;
a developing unit for visualizing the electrostatic latent image into a toner image;
a transfer unit for transferring the toner image formed on the photoconductive medium onto a paper; and
a control unit for controlling a voltage applied to the photoconductive medium according to a resistance of the paper.

2. The apparatus of claim 1, wherein the control unit measures the resistance of the paper, and transfers the image to the paper by maintaining a current electrifying potential if the measured resistance of the paper is lower than a predetermined value and lowering the current electrifying potential of the photoconductive medium if the measured resistance of the paper is equal to or greater than the predetermined value.

3. The apparatus of claim 1, further comprising a sensor for measuring the resistance of the paper, the sensor being operatively connected to the control unit.

4. The apparatus of claim 3, wherein the control unit maintains the electrifying potential applied to the photoconductive medium at a constant present value when the measured resistance of the paper is below a predetermined value.

5. The apparatus of claim 3, wherein the electrifying potential applied to the photoconductive medium is reduced from a present value when the measured resistance of the paper is equal to or greater than a predetermined value.

6. The apparatus of claim 5, wherein the control unit reduces the electrifying potential applied to the photoconductive medium to a value to prevent an increase in image density.

7. The apparatus of claim 5, wherein the control unit reduces the electrifying potential applied to the photoconductive medium from a first operating value by less than 15%.

8. The apparatus of claim 5, wherein the control unit reduces the electrifying potential applied to the photoconductive medium from a first operating value by 5% to 10%.

9. The apparatus of claim 1, further comprising
a sensor to measure the resistance of the paper, wherein the control unit maintains the electrifying potential applied to the photoconductive medium at a first value when the paper has a resistance lower than a predetermined value and wherein the control unit lowers the electrifying potential of the photoconductive medium to a second value below the first value when the paper has a resistance equal to or greater than the predetermined value.

10. A method of improving transfer properties of an electrophotographic image forming apparatus, comprising:
electrifying a surface of a photoconductive medium by applying a voltage to the photoconductive medium;
forming an electrostatic latent image on the surface of the electrified photoconductive medium;
forming a visible image by supplying toner to the surface of the photoconductive medium having the electrostatic latent image; and
transferring the visible image from the photoconductive medium onto a paper,
wherein, in the transferring step, the resistance of the paper is measured, and the image transfer is performed by maintaining a current electrifying potential if the measured resistance of the paper is lower than a predetermined value and lowering the current electrifying potential of the photoconductive medium if the measured resistance of the paper is equal to or greater than the predetermined value.

11. The method of claim 10, wherein, in the transferring step, when the resistance of the paper is equal to or greater than the predetermined value, a voltage applied to a developing unit is lowered below a current developing voltage, and the applied voltage for the photoconductive medium is lowered below the current electrifying potential.

12. The method of claim 10, wherein when the resistance of the paper is equal to or greater than the predetermined value, the applied voltage for the photoconductive medium is lowered by less than 15% with respect to the current electrifying potential.

13. The method of claim 12, wherein when the resistance of the paper is equal to or greater than the predetermined value, the applied voltage for the photoconductive medium is lowered by 5-10% with respect to the current electrifying potential.

14. The method of claim 11, wherein, in the transferring step, when the resistance of the paper is equal to or greater than the predetermined value, an alternating current (AC) or direct current (DC) applied voltage for the developing unit is lowered below a current developing voltage.

15. The method of claim 10, wherein the applied voltage for the photoconductive medium is automatically set according to the resistance of the paper, through mode selection by a computer.

16. A method of producing an image on a paper in an electrophotographic image forming apparatus, the method comprising:
applying a voltage to electrify a surface of a photoconductive medium;
forming an electrostatic latent image on the surface of the electrified photoconductive medium;
forming a visible image on the photoconductive medium by applying toner to the electrostatic latent image;
measuring the resistance of a paper and maintaining the electrifying potential of the photoconductive medium when the resistance of the paper is less than a predetermined first value, and lowering the electrifying potential of the photoconductive medium when the resistance of the paper is greater than or equal to the first value; and
transferring the visible image to the paper.

17. The method of claim 16, wherein the electrifying potential of the photoconductive medium is adjusted to a value to prevent an increase in image density.

18. The method of claim 16, comprising providing a computer control device and automatically measuring the resistance of the paper and adjusting the applied voltage of the photoconductive medium in response to the measured resistance.

19. The method of claim 16, wherein the voltage applied to the photoconductive medium is form an alternating current or a direct current.
